(19) United States
(12) Patent Application Publication
(10) Pub. No.: US 2016/0218939 A1
(43) Pub. Date: Jul. 28, 2016

(54) DISTRIBUTED MULTI-SITE CLOUD DEPLOYMENT

(71) Applicant: Hewlett-Packard Development Company, L.P., Houston, TX (US)

(72) Inventor: Arvind Tiwari, Fort Collins, CO (US)

(21) Appl. No.: 14/607,244

(22) Filed: Jan. 28, 2015

(51) Int. Cl. H04L 12/24; H04L 12/927; H04L 29/08

(52) U.S. Cl. CPC H04L 41/5054; H04L 67/10; H04L 47/80

(57) ABSTRACT

Distributed multi-site cloud deployment in one example implementation can include communicating via a virtual private network between a first cloud region and a second cloud region and accessing, from a first computing resource, at least a portion of a second computing resource, wherein the first computing resource is disposed in the first cloud region and the second computing resource is disposed in the second cloud region.

### BACKGROUND

Computing resources can be distributed across different cloud regions, which can be located in disparate geographic locales. Communication between such distributed computing resources can be facilitated.

### BRIEF DESCRIPTION OF THE DRAWINGS

FIG. 1 illustrates a diagram of an example of a system according to the present disclosure.

FIG. 2 illustrates a diagram of an example computing device according to the present disclosure.

FIG. 3 illustrates an example of distributed multi-site cloud deployment according to the present disclosure.

FIG. 4 illustrates an example of distributed multi-site cloud deployment according to the present disclosure.

FIG. 5 illustrates a flow diagram of an example method of distributed multi-site cloud deployment according to the present disclosure.

FIG. 6 illustrates a diagram of an example system including a processor and non-transitory computer readable medium storing executable instructions according to the present disclosure.

### DETAILED DESCRIPTION

Facilitating access to computing resources that are distributed across multiple regions and/or geographies can be difficult due to a number of factors. One such factor can be presented in the form of challenges to maintaining and/or upgrading such resources. For example, implementing software upgrades, hardware upgrades, and/or configuration changes across multiple computing resources in disparate geographies can be time-consuming, costly, and can lead to delays in triaging problems. In addition, connecting distributed computing resources can involve using leased lines, which can lead to tight coupling, and can involve complicated architectures that can become increasingly complex when scaled. Other challenges to providing massive computing resource capabilities across multiple regions can include challenges in integrating public and private clouds and challenges in setting up a multi-region cloud across multiple resources controlled by different entities. In addition, costs can pose a challenge to facilitating access to distributed computing resources.

Currently available methods of addressing these challenges suffer from a number of shortcomings. Examples of such shortcomings include: lack of a plug and play paradigm, difficulties and costs associated with scaling, and costs associated with providing adequate data redundancy, especially as the number of regions and/or geographies grows.

In contrast, some examples of facilitating access to computing resources that are distributed across multiple regions and/or geographies according to the present disclosure include utilizing virtual private networks (VPNs) to enable communication between computing resources in disparate cloud environments. This can allow for simplified expansion of distributed cloud networks, and can lead to cost savings in increasing the quantity of computing resources and/or cloud regions in a distributed cloud environment.

Examples of the present disclosure include methods, systems, and computer-readable and executable instructions for distributed multi-site cloud deployment. Advantageously, distributed multi-site cloud deployment can provide plug and play integration of disparate computing resources that are distributed across multiple regions and/or geographies. Examples include loosely coupling data centers across peer to peer VPNs.

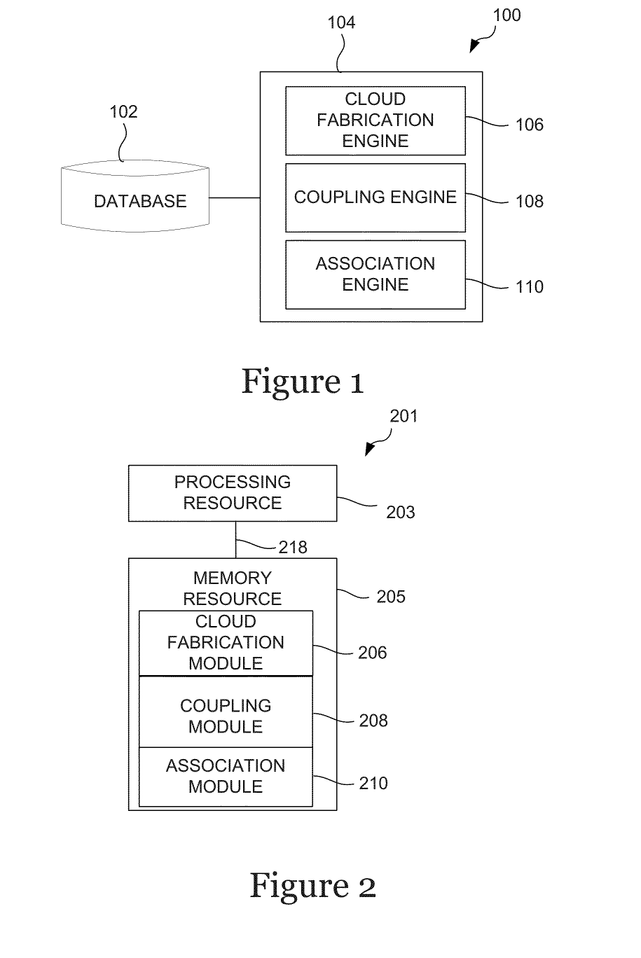

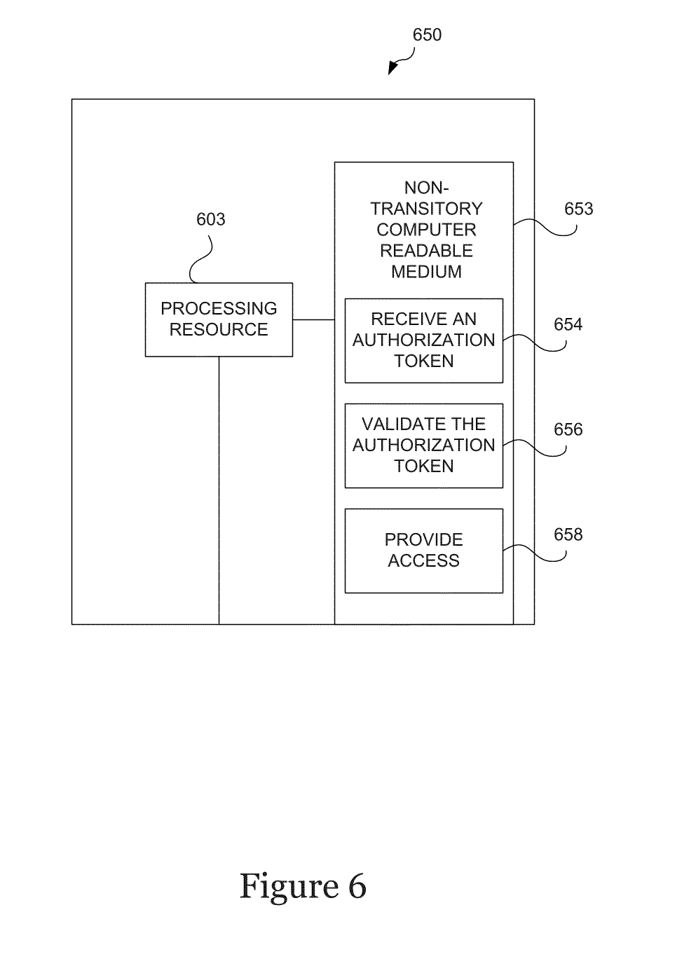

FIG. 1 illustrates a diagram of an example of a system according to the present disclosure. As shown in the example of FIG. 1, the system 100 can include a database 102 accessible by and in communication with a plurality of engines 104. The engines 104 can include a cloud fabrication engine 106, a coupling engine 108, and an association engine 110. The system 100 can include additional or fewer engines than illustrated to perform the various functions described herein and embodiments are not limited to the example shown in FIG. 1. The system 100 can include hardware, e.g., in the form of transistor logic and/or application specific integrated circuitry (ASICs), firmware, and software, e.g., in the form of machine readable and executable instructions (program instructions (programming) stored in a machine readable medium (MRM)) which in cooperation can form a computing device as discussed in connection with FIG. 2 and FIG. 6.

The plurality of engines can include a combination of hardware and software, e.g., program instructions, but at least includes hardware that is configured to perform particular functions, tasks and/or actions. For example, the engines shown in FIG. 1 can be used to provide a first and second cloud region, provide inter-cloud communication between the first cloud region (e.g., a cloud containing a computing resource and/or data center located in a first geographic region) and the second cloud region (e.g., a cloud containing a computing resource and/or data center located in a second geographic region), and associate at least a portion of a first computing resource with at least a portion of a second computing resource. As used herein, “inter-cloud communication” is communication between an interconnected plurality of clouds. In some examples, the first computing resource can be disposed in the first cloud region and the second computing resource can be disposed in the second cloud region. As a further example, the first and second cloud regions can provide a single cloud service or plurality of cloud services. As used herein, a “cloud service” is any service provided and/or accessible to a cloud or plurality of clouds (e.g., a plurality of servers and/or software networks that can facilitate access and/or storage to computer services and/or resources).

For example, the cloud fabrication engine 106 can include hardware and/or a combination of hardware and program instructions to provide a first cloud region and to provide a second cloud region. In some examples, a session key can be transmitted from the second computing resource and received at the first computing resource. The session key can be an advanced encryption standard (AES) key. As used herein, a “session key” is a single use symmetric key for encrypting messages in a communication session. In some examples, the first cloud region can use a first directory service (e.g., an enterprise active directory (AD)) and the second cloud region can use a second directory service. Examples are not so limited however, and the first and second cloud regions can use the same directory service. As used herein, a “directory service” is a software system that stores, organizes, and/or provides access to information in a computer operating system's directory.

In some examples, the cloud fabrication engine 106 can assign a first Cloud Identification (Cloud ID) to a first cloud region and can assign a second Cloud ID to a second cloud region. The first Cloud ID can provide a first scope of access to a first computing resource, and the second Cloud ID can provide a second scope of access to a second computing resource. In some examples, a Cloud ID can be passed in a communication header to route requests from one cloud region to another cloud region. As used herein, a “Cloud ID” provides a scope of access to a computing resource.

As used herein, a “token” is an authorization security device that can be used to control access rights to computing resources or portions of computing resources. In some examples, a token can be software based (e.g., an X-Auth token). Validation of the token can include signature validation and/or inter-cloud ticket (ICT) decryption. As used herein, an “inter-cloud ticket” is used for inter-cloud communication (e.g., resource discovery, token validation across clouds, etc.). In some examples, an inter-cloud ticket can be a public key infrastructure (PKI) ticket that can hold context information that can be used for communication. The ticket can be encrypted using a public key from a destination resource and/or can be signed by a source resource private key.

The coupling engine 108 can include hardware and/or a combination of hardware and program instructions to provide an inter-cloud communication via a virtual private network (VPN) between the first cloud region and the second cloud region. In some examples, the coupling engine 108 can provide communication between the first and second cloud regions via a virtual private network (VPN). In addition, the coupling engine 108 can propagate an authentication token to a third computing resource. In some examples, the coupling engine 108 can configure the first computing resource and the second computing resource using a representational state transfer (REST) application programming interface (API).

The association engine 110 can include hardware and/or hardware and program instructions to associate at least a portion of a first computing resource disposed in the first cloud region with at least a portion of a second computing resource disposed in the second cloud region. The first computing resource and the second computing resource can be located in different geographic regions. In some examples, the first computing resources can be disposed in a first data center, and the second computing resources can be disposed in a second data center. For example, the first computing resources can be located in a first data center in a first cloud region and the second computing resources can be located in a second data center in a second cloud region. The first data center and the second data center can be located in different geographies and/or locales. In some examples, the first computing resource can be provided with access to at least part of the second computing resource in a distributed cloud environment. That is, the association engine 110 can allow the first computing resources to access at least a portion of the second computing resources. In some examples, the association engine can cause the first cloud region and the second cloud region to operate as a single cloud region. That is, the various cloud regions can operate or appear to operate as a single cloud service. In some examples, the first computing resources and the second computing resources, and/or the first data center and the second data center can be in communication via a VPN.

Embodiments are not limited to the example engines shown in FIG. 1 and one or more engines described may be combined or may be a sub-engine of another engine. Further, the engines shown may be remote from one another in a distributed computing environment, cloud computing environment, etc.

FIG. 2 illustrates a diagram of an example computing device according to the present disclosure. The computing device 201 can utilize hardware, software (e.g., program instructions), firmware, and/or logic to perform a number of functions described herein. The computing device 201 can be any combination of hardware and program instructions configured to share information. The hardware can, for example, include a processing resource 203 and a memory resource 205 (e.g., computer or machine readable medium (CRM/MRM), database, etc.). A processing resource 203, as used herein, can include one or more processors capable of executing instructions stored by the memory resource 205. The processing resource 203 may be implemented in a single device or distributed across multiple devices. The program instructions (e.g., computer or machine readable instructions (CRI/MRI)) can include instructions stored on the memory resource 205 and executable by the processing resource 203 to perform a particular function, task and/or action (e.g. provide a first cloud region, provide a second cloud region, etc.).

The memory resource 205 can be a non-transitory machine readable medium, include one or more memory components capable of storing instructions that can be executed by a processing resource 203, and may be integrated in a single device or distributed across multiple devices. Further, memory resource 205 may be fully or partially integrated in the same device as processing resource 203 or it may be separate but accessible to that device and processing resource 203. Thus, it is noted that the computing device 201 may be implemented on a participant device, on a server device, on a collection of server devices, and/or a combination of a participant, (e.g., user/consumer endpoint device), and one or more server devices as part of a distributed computing environment, cloud computing environment, etc.

The memory resource 205 can be in communication with the processing resource 203 via a communication link (e.g., a path) 218. The communication link 218 can provide a wired and/or wireless connection between the processing resource 203 and the memory resource 205.

In the example of FIG. 2, the memory resource 205 includes a cloud fabrication module 206, a coupling module 208, and an association module 210. As used herein a module can include hardware and software (e.g., program instructions), but includes at least software that can be executed by a processing resource, for example, processing resource 203, to perform a particular task, function and/or action. The plurality of modules may be combined or may be sub-modules of other modules. As shown in FIG. 2, the cloud fabrication module 206, the coupling module 208, and the association module 210 can be individual modules located on one memory resource 205. Embodiments are not so limited, however, and a plurality of modules can be located at separate and distinct memory resource locations, for example, in a distributed computing environment, cloud computing environment, etc.

Each of the plurality of modules can include instructions that when executed by the processing resource 203 can function as an engine such as the engines described in connection with FIG. 1. For example, the cloud fabrication module 206 can include instructions that when executed by the processing resource 203 can function as the cloud fabrication engine 106 shown in FIG. 1. The coupling module 208 can include instructions that when executed by the processing resource 203 can function as the coupling engine 108 shown in FIG. 1. Additionally, the association module 210 can include instructions that when executed by the processing resource 203 can function as the association engine 110 shown in FIG. 1.

Embodiments are not limited to the example modules shown in FIG. 2 and in some cases a number of modules can operate together to function as a particular engine. Further, the engines and/or modules of FIGS. 1 and 2 can be located in a single system and/or computing device or reside in separate distinct locations in a distributed network, cloud computing, enterprise service environment (e.g., Software as a Service (SaaS) environment), etc.

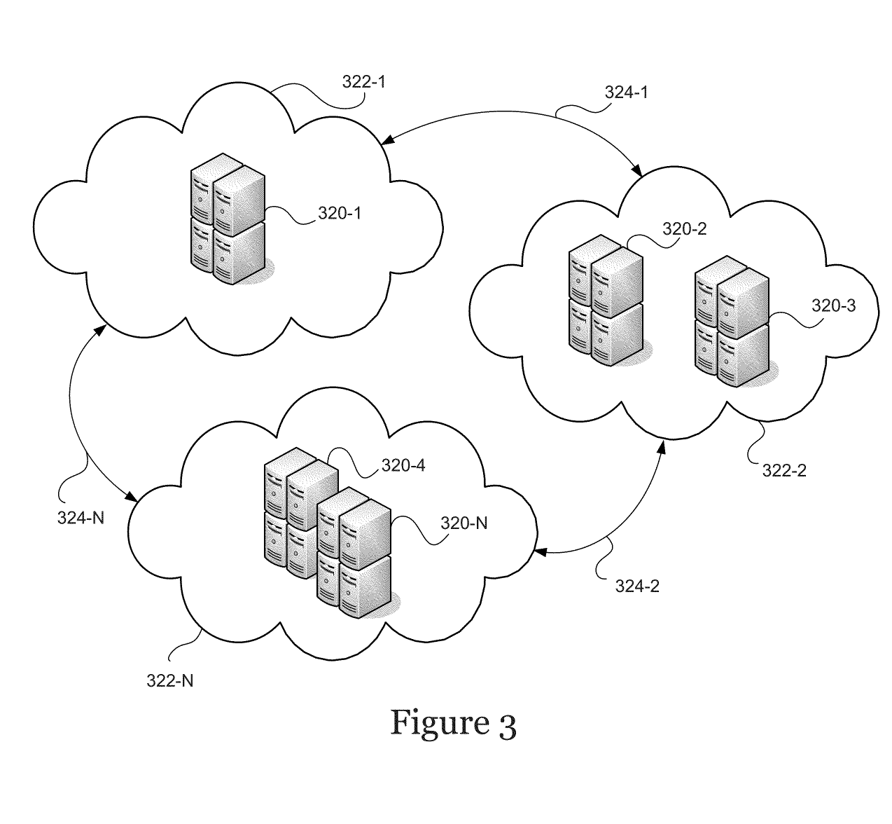

FIG. 3 illustrates an example of distributed multi-site cloud deployment according to the present disclosure. In contrast to using leased lines to facilitate distributed multi-cloud deployment, the example shown in FIG. 3 illustrates VPN communication between a plurality of cloud regions, each cloud region including at least one data center, for example, at least one data center including at least one computing resource. As previously described herein, VPN communication between disparate data centers (e.g., data centers including computing resources) located in different cloud regions can alleviate problems associated with providing communication across leased lines. In this regard data exchanged between a plurality of data centers can be facilitated on a secure peer-to-peer VPN as opposed to across dedicated and/or leased lines.

In the example of FIG. 3, a plurality of data centers 320-1, 320-1, . . . , 320-N can be distributed across a plurality of cloud regions 322-1, 322-1, . . . , 322-N. Each of the plurality of data centers 320-1, 320-1, . . . , 320-N can include corresponding computing resources. In some examples, the cloud regions 322-1, 322-2, . . . , 322-N can be in communication across a number of communication paths 324-1, 324-2, . . . , 324-N. The communication paths 324-1, 324-2, . . . , 324-N can facilitate communication between the could regions 322-1, 322-2, . . . , 322-3 over a virtual private network (VPN). For example, the communication paths 324-1, 2324-2, . . . , 324-N can facilitate inter-cloud communication over a peer to peer or point to point VPN.

In some examples, a first data center 320-1 disposed in a first cloud region 322-1 can include first computing resources. A second data center 320-2 disposed in a second cloud region 322-2 can include second computing resources. The first data center 320-1 and the second data center 320-2 and/or the first cloud region 322-1 and the second cloud region 322-2 can be in communication via a communication path 324-1. In some examples, the second data center 320-2 can receive an authorization token from the first data center 320-1 over the communication path 324-1. The authorization token can be validated at the second data center 320-2 to provide access to at least a portion of the second computing resources based on the validation of the authorization token.

The first cloud region 322-1 can be referred to as a host cloud. As used herein, the “host cloud” consumes resources from different cloud providers. The second cloud region 322-2 can be referred to as a partner cloud. As used herein, a “partner cloud” offers its services to a host cloud entity. More than one cloud region 322-1, 322-2, . . . , 322-N can communicate to facilitate the consumption of resources by the host cloud and the offer of services from the partner cloud. In this regard, more than one cloud region 324-1, 324-2, . . . , 324-N can be paired. For example, the first cloud region 322-1 and the second cloud region 322-2 can provision respective resources so as to operate or appear to function as a single cloud service and/or cloud region.

Cloud pairing can allow for more than one cloud region 324-1, 324-2, . . . , 324-N to work in alliance. As used herein, “cloud pairing” refers to steps that establish trust between cloud regions 322-1, 322-2, . . . , 322-N and configure artifacts. As used herein, “artifacts” refer to tangible by-products produced by software. For example, artifacts can include cryptographic keys, cloud identifiers, region and/or zone information, service availability, and/or inter-cloud federation service endpoints. In some examples, cloud pairing can be achieved manually by cloud providers. However, examples are not so limited, and cloud pairing can also be achieved automatically. A host cloud provider can configure artifacts for partner cloud entities and the partner cloud provider can configure artifacts for the host cloud entity. Cloud pairing can be bidirectional or unidirectional. That is, one cloud entity can be a host cloud for one or more partner clouds and/or a partner cloud for one or more host clouds.

Individual cloud regions 322-1, 322-1, . . . , 322-N can have a single provider or multiple providers. For example, in a private deployment, individual cloud regions 322-1, 322-2, 322-N can use a single enterprise active directory (AD). As a further example, in a public cloud deployment, individual cloud regions 322-1, 322-2, . . . , 322-N can have separate identity providers, and/or can use different enterprise ADs.

In some examples of distributed multi-site cloud deployment, various resources can be provisioned (e.g., “scoped”). For example, access to computing resources 320-1, . . . , 320-2, . . . , 320-N from different peers can be provisioned based at least in part on validation of a peer's authentication token. As used herein, “peers” are various data providers and/or data consumers in a distributed multi-site cloud deployment. A provisioned token can grant different access to computing resources 320-1, 320-2, . . . , 320-N than the authentication token. In some examples, a provisioned token may be provided in response to a request for a provisioned token. A provisioned token can allow access to information corresponding to resources across a plurality of cloud regions 322-1, 322-2, . . . , 322-N. This can allow for a federated view of resources across a plurality of cloud regions 322-1, 322-2, . . . , 322-N. For examples, resources from different peers can be provisioned to a local project (e.g., a local Keystone® project) of one or more partners.

In distributed multi-site cloud deployment, each cloud peer (e.g., each partner, each user, each data center, etc.) can be assigned an identification. For example, each cloud peer can be assigned a cloud identification (Cloud ID) which can be used to assess resources associated with the cloud peer. In some examples, the Cloud ID can be passed in a communication header to, for example, route requests to an appropriate peer. In addition, a secure representational state transfer (REST) application programming interface (API) can be provided for administration and configuration.

In some examples, peer to peer communication, for example, peer to peer communication across a communication path 324-1, 324-1, . . . , 324-N can be initiated with a secure handshake. Session keys can be obtained through the secure handshake process. As used herein, “session keys” are advanced encryption standard (AES) keys that can be used to enforce message level security while data is transmitted. In some examples, an inter-cloud ticket (ICT) can be used to request and transmit session keys across a communication path 324-1, 324-1, . . . , 324-N. As discussed in more detail herein, the ICT can be a PKI ticket that contains context information for communication. In some examples, the ICT can utilize configured PKI artifacts.

Remote procedure call (RPC) APIs can be used to facilitate communication between multiple peers. RPC APIs can address resource provisioning and/or state synchronization requests from multiple peers in a cloud environment. In a distributed multi-site cloud deployment, RPC APIs can communicate with underpinning cloud services (e.g., Nova®, Cinder®, etc.) to provide interfaces, as discussed in more detail herein. In some examples, the APIs can propagate an inter-cloud request to a respective service that manages and/or owns a computing resource.

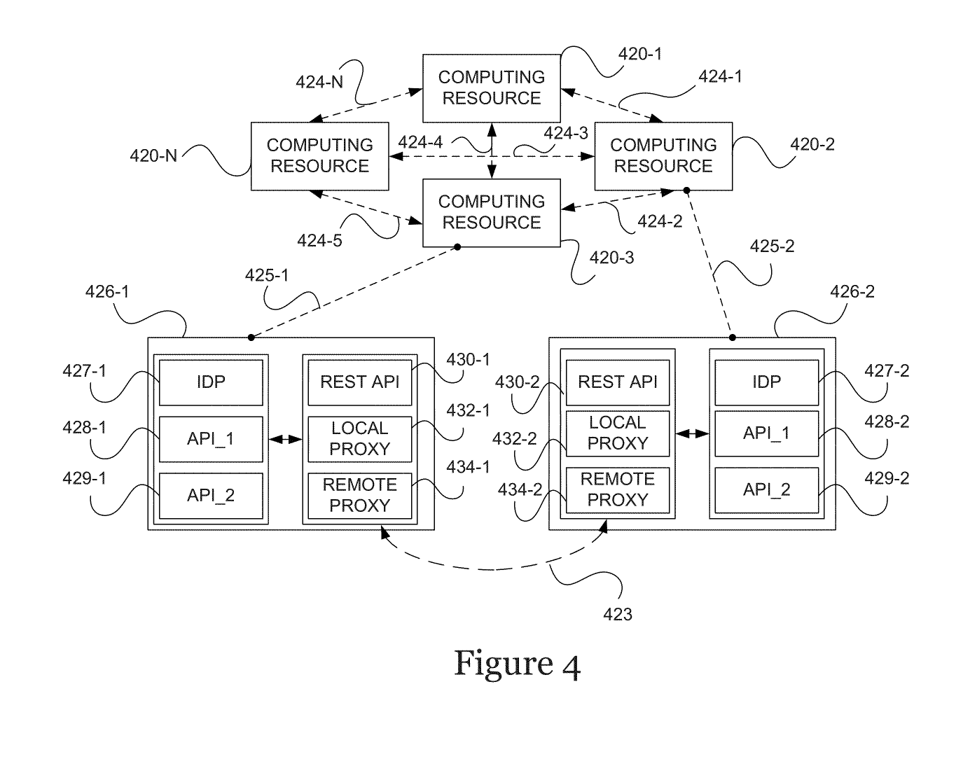

FIG. 4 illustrates an example of distributed multi-site cloud deployment according to the present disclosure. In operation, the various components illustrated in FIG. 4 can facilitate communication between a plurality of computing resources (e.g., a plurality of data centers each including at least one computing resource) that can be located in disparate geographic locations. For example, resources located on a plurality of computing resources can be distributed or federated when communication between a plurality of computing resources is facilitated in the example illustrated in FIG. 4. Further, as discussed in more detail below, the first computing resource can include a first plurality of service resources and the second computing resource can include a second plurality of service resources, wherein the first plurality of service resources and the second plurality of service resources include at least one identity provider and at least one project. As used herein, “services resources” include resources to communicate with underpinning cloud services (e.g., Nova®, Cinder®, Alliance®, etc.) and/or projects (e.g., Keystone®, etc.).

A plurality of computing resources 420-1, 420-2, . . . , 420-N can be in communication across a plurality of communication paths 424-1, 424-2, . . . , 424-N. The communication paths can be point to point VPN communication paths. In some examples, each of the plurality of computing resources 420-1, 420-2, . . . , 420-N can include a service (e.g., Alliance® service) to facilitate communication between the peers and/or the service resources 426-1, 426-2. The plurality of computing resources 420-1, 420-2, . . . , 420-N can be in communication with a plurality of service resources 426-1, 426-2. In some examples, a service resource (e.g., service resource 426-1) can be in communication with a data center (e.g., data center 420-3) as indicated by communication line 425-1. Service resources 426-1, 426-2 can provide a plurality of services 427-1, 428-1, 429-1, 430-1, 432-1, 434-1, etc. to one or more of the plurality of computing resources 420-1, 420-2, . . . , 420-N. In some examples, service resources 426-1, 426-2 can be in communication via a communication path, for example, communication path 423. Service resources 426-1, 426-2 can include a combination of program instructions and/or hardware that can be configured to perform particular functions, tasks, and/or actions. Service resources 426-1, 426-2 can be integrated and/or distributed across one or more physical devices. In addition, service resources 426-1, 426-2 can be located in one or more regions of a distributed cloud.

Service resources 426-1, 426-2 can include an identity provider (IDP) 427-1, 427-2, API_1 428-1, 428-2, API_2 429-1, 429-2, REST APIs 430-1, 430-2, local proxy 432-1, 432-2, and/or remote proxy 434-1, 434-2. In some examples, service resource 426-1, 426-2 can facilitate communication between the plurality of computing resources 420-1, 420-2, . . . , 420-N. Service resources 426-1, 426-2 can be configured to address resource provisioning and/or state synchronization requests from one or more cloud regions.

In some examples, IDP 427-1, 427-2 can validate an authentication token. As used here, an “IDP” provides identifiers to users and/or a first computing resource that want to interact with a second computing resource. In some examples, the IDP can include a project or plurality of projects (e.g., Keystone® project(s)). API_1 428-1, 428-2 can include APIs configured to perform tasks and/or functions underpinning cloud services. For example, API_1 can include various clients that can interact with various services and can be configured to facilitate distributed multi-site cloud deployment. Some examples of clients included in API_1 428-1, 428-2 can include Nova® and Cinder®. API_2 429-1, 429-2 can be configured to networking as a service between interface devices. For example, API_2 429-1, 429-2 can include a Neutron® API.

REST API 430-1, 430-2 can include RPC APIs and can communicate with more than one peer. In some examples, REST API 430-1 can include a service (e.g., Alliance® service) to facilitate communication between the peers. Local proxy 432-1, 432-2 and remote proxy 434-1, 434-2 can act as intermediaries for various requests among the plurality of computing resources 420-1, 420-2, . . . , 420-N and can act as intermediaries for various requests among the service resource 426-1, 426-2.

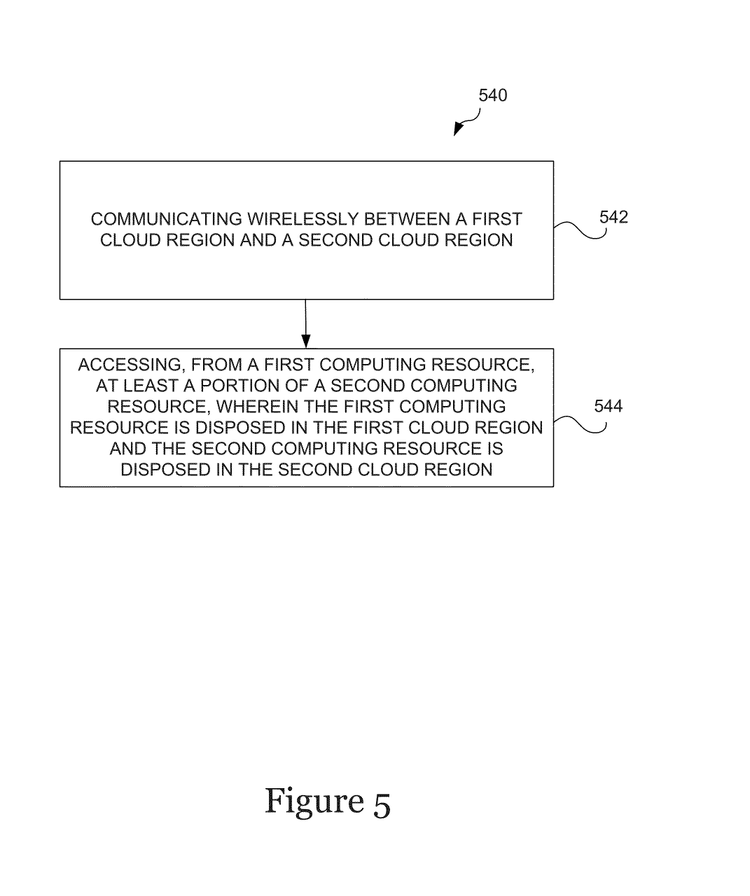

FIG. 5 illustrates a flow diagram for an example method for distributed multi-site cloud deployment according to the present disclosure. In various examples, the method 540 can be performed using the system 100 shown in FIG. 1 and/or the computing device and modules 201 shown in FIG. 2. Examples are not, however, limited to these example systems, devices, and/or modules.

At 542, the method 540 can include communicating wirelessly between a first cloud region and a second cloud region. In some examples, a first computing resource can be disposed in the first cloud region, and the second computing resource can be disposed in the second cloud region. In some examples, communicating wirelessly can include communicating via a peer-to-peer VPN. The method can include configuring the first computing resource and the second computing resource through a representational state transfer (REST) application programming interface (API). The method can also include requesting an ICT, receiving the ICT, and transmitting a session key in response to receiving the ICT. In various examples, as described above, communicating wirelessly between a first cloud region and a second cloud region can be executed using the coupling engine 108 and/or the coupling module 208, illustrated in FIGS. 1 and 2.

At 544, the method 540 can include accessing, from a first computing resource, at least a portion of a second computing resource, wherein the first computing resource is disposed in the first cloud region and the second computing resource is disposed in the second cloud region. In various examples, as described above, accessing, from a first computing resource, at least a portion of a second computing resource can be executed using the association engine 110 and/or the association module 210, illustrated in FIGS. 1 and 2. In some examples, the method 540 can include assigning a first Cloud ID to the first computing resource, and assigning a second Cloud ID to the second computing resource. The first Cloud ID can be transmitted from the first computing resource to the second computing resource, and at least a portion of a second computing resource can be accessed from the first computing resource in response to the second computing resource receiving the first Cloud ID.

FIG. 6 illustrates a diagram of an example system 650 including a processor 603 and non-transitory computer readable medium 653 according to the present disclosure. For example, the system 650 may be an implementation of the example system of FIG. 1 or the example computing device of FIG. 2.

The processor 603 may be configured to execute instructions stored on the non-transitory computer readable medium 653. For example, the non-transitory computer readable medium 653 may be any type of volatile or non-volatile memory or storage, such as random access memory (RAM), flash memory, read-only memory (ROM), storage volumes, a hard disk, or a combination thereof.

The example medium 653 may store instructions 654 executable by the processor 653 to facilitate distributed multi-site cloud deployments. For example, the processor 653 may execute the instructions 654 to receive an authorization token from a first computing resource. For example, the instructions 654 can be executable by the processor 603 receive a session key from the first computing resource and transmit the session key from the second computing resource. The session key can be an advanced encryption standard (AES) key. In some examples, the session key can be received in response to receiving an inter-cloud ticket (ICT).

The example medium 653 may further store instructions 656. The instructions 656 can be executable to validate an authorization token. For example, the authorization token may be a PKI token or an X-Auth token. In addition, a single token that is issued from the host cloud can be validated by more than one computing resource in one or more cloud regions.

The example medium 653 may further store instructions 658. The instructions 658 can be executable to provide access to at least a portion of the second computing resource in response to validation of the authorization token. For example, instructions stored on the example medium 653 can be executable by the processor 603 to allow a first computing resource in a first cloud region to access a second computing resource in a second cloud region. In addition, instructions stored on the example medium 653 can be executable by the processor 603 to allow a first computing resource in a first cloud region to access a third computing resource in a third cloud region In some examples, instructions stored on the example medium 653 can be further executable to configure the first computing resource and the second computing resource using a representational state transfer (REST) application programming interface (API). The instructions stored on the example medium 653 can be executed to use a plurality of remote procedure call application programming interfaces to provide state synchronization between the first computing resource and the second computing resource. In addition, the instructions stored on the example medium 653 can be executed to propagate the authorization token to a third computing resource and provide access to at least a portion of the third computing resource.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. For example, reference numeral 102 may refer to element “02” in FIG. 1 and an analogous element may be identified by reference numeral 203 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. Further, as used herein, “a number of” an element and/or feature can refer to one or more of such elements and/or features.

As used herein, “logic” is an alternative or additional processing resource to perform a particular action and/or function, etc., described herein, which includes hardware, for example, various forms of transistor logic, application specific integrated circuits (ASICs), etc., as opposed to computer executable instructions, for example, software firmware, etc., stored in memory and executable by a processor.

What is claimed:

1. A system, comprising:
a cloud fabrication engine to:
provide a first cloud region; and
provide a second cloud region;
a coupling engine to provide an inter-cloud communication via a virtual private network between the first cloud region and the second cloud region; and
an association engine to associate at least a portion of a first computing resource disposed in the first cloud region with at least a portion of a second computing resource disposed in the second cloud region, wherein the first computing resource and the second computing resource are located in different geographic regions.

2. The system of claim 1, wherein the first computing resources are disposed in a first data center and the second computing resources are disposed in a second data center.

3. The system of claim 1, the association engine to cause the first cloud region and the second cloud region to operate as a single cloud region.

4. The system of claim 1, the cloud fabrication engine to:
assign a first Cloud Identification (ID) to the first cloud region; and
assign a second Cloud ID to the second cloud region, wherein the first Cloud ID provides a first scope of access to the first computing resource and the second Cloud ID provides a second scope of access to the second computing resource.

5. The system of claim 1, wherein the first cloud region uses a first directory service and the second cloud region uses a second directory service.

6. The system of claim 1, wherein the first computing resource includes a first plurality of service resources and the second computing resource includes a second plurality of service resources, wherein the first plurality of service resources and the second plurality of service resources include at least one identity provider and at least one project.

7. A method, comprising:
communicating via a virtual private network VPN between a first cloud region and a second cloud region; and
accessing, from a first computing resource, at least a portion of a second computing resource, wherein
the first computing resource is disposed in the first cloud region; and
the second computing resource is disposed in the second cloud region.

8. The method of claim 7, comprising:
requesting an inter-cloud ticket (ICT);
receiving the ICT; and
transmitting a session key in response to receiving the ICT.

9. The method of claim 8, comprising:
assigning a first Cloud Identification (ID) to the first computing resource;
assigning a second Cloud ID to the second computing resource;
transmitting the first Cloud ID from the first computing resource to the second computing resource; and
accessing from the first computing resource, the at least a portion of a second computing resource in response to the second computing resource receiving the first Cloud ID.

10. A non-transitory computer readable medium storing instructions executable by a processing resource to:
enable communication between a first computing resource and a second computing resource via a virtual private network (VPN);
receive an authorization token from the first computing resource;
validate the authorization token;
provide access to at least a portion of the second computing resource based on validation of the authorization token, wherein the first computing resource is disposed in a first cloud region and the second computing resource is disposed in a second cloud region.

11. The non-transitory medium of claim 9, wherein the instructions are executable by the processing resource to use a plurality of remote procedure call application programming interfaces to provide state synchronization between the first computing resource and the second computing resource.

12. The non-transitory medium of claim 9, wherein the instructions are executable by the processing resource to:
receive a session key from the first computing resource; and
transmit the session key to the second computing resource.

13. The non-transitory medium of claim 12, comprising receiving the session key in response to receiving an inter-cloud ticket.

14. The non-transitory medium of claim 9, wherein the instructions are executable by the processing resource to configure communication between the first computing resource and the second computing resource using a representational state transfer (REST) application programming interface (API).

15. The non-transitory medium of claim 9, wherein the instructions are executable by the processing resource to:
propagate the authorization token to a third computing resource; and
provide access to at least a portion of the third computing resource.
